(19) United States
(12) Patent Application Publication
(10) Pub. No.: US 2021/0323298 A1
(43) Pub. Date: Oct. 21, 2021

(54) CONDITIONING ROLLERS

(71) Applicant: HEWLETT-PACKARD DEVELOPMENT COMPANY, L.P., SPRING, TX (US)

(72) Inventors: Jose Angel Villasante Bembibre, Sant Cugat del Valles (ES); Ricardo Oltra Ramirez, Sant Cugat del Valles (ES); Lluis Sole Enrech, Sant Cugat del Valles (ES); Jose Garcia Martinez, Sant Cugat del Valles (ES)

(73) Assignee: HEWLETT-PACKARD DEVELOPMENT COMPANY, L.P., SPRING, TX (US)

(21) Appl. No.: 17/273,040

(22) PCT Filed: Sep. 14, 2018
(86) PCT No.: PCT/US2018/051109

§ 371 Date: Mar. 3, 2021

(51) Int. Cl. B41F 7/26; B41F 23/02; B41F 23/04; B41L 23/20

(52) U.S. Cl. CPC B41F 7/265; B41L 23/20; B41F 23/04; B41F 23/02

(57) ABSTRACT

It is disclosed a conditioning roller for use within a printing system. The conditioning roller comprises: a roller body comprising an inner volume and an outer surface; a conditioning media attached to the outer surface of the roller body; a heating element; and a fluid dispensing mechanism. The heating element and the fluid dispensing mechanism are provided to act on the conditioning media from the inner volume of the roller body as to heat or wet the conditioning media.

### BACKGROUND

Printers are, in general terms, devices that modify a substrate as to incorporate an image. In some cases, substrates may be conditioned previously to a print proceeding of after such proceeding to make sure that the image quality is consistent. Also, this helps having substantially uniform media, e.g., with a similar humidity or temperature.

Examples of printers that may make use of a conditioning roller according to the present disclosure may be inkjet printers, laser printers, offset presses, or digital presses.

### BRIEF DESCRIPTION OF THE DRAWINGS

Various example features will be apparent from the detailed description which follows, taken in conjunction with the accompanying drawings, wherein:

FIG. 1 schematically illustrates a printing system according to an example.

FIG. 2 shows a side view of a printing system including a conditioning roller according to an example.

FIG. 3 shows a perspective view of an example of a conditioning roller and an example implementation in a printing system.

FIG. 4 shows a further example of a conditioning roller and a further example implementation in a printing system.

FIG. 5 shows an example of flowchart of an example of a printing method.

### DETAILED DESCRIPTION

In the following description and figures, some example implementations of print apparatus, print systems, and/or methods of printing are described. In examples described herein, a “print apparatus” may be a device to print content on a physical medium (e.g., paper, textile, vinyl, etc.) with a print material (e.g., ink or toner). For example, the print apparatus may be a wide-format print apparatus that prints latex-based print fluid on a print medium, such as a print medium that is size A2 or larger. In some examples, the physical medium printed on may be a web roll or a pre-cut sheet. A print apparatus may utilize suitable print consumables, such as ink, toner, fluids or powders, or other raw materials for printing. An example of fluid print material is a water-based latex ink ejectable from a print head, such as a piezoelectric print head or a thermal inkjet print head. Other examples of print fluid may include dye-based color inks, pigment-based inks, solvents, gloss enhancers, fixer agents, and the like.

The quality of an image printed on a substrate depends on different factors, one of the factors that have a clear impact on a print is the physical properties of the substrate that is to be printed. In some cases, jobs that are printed using identical printing parameters differ from one another substantially due to the differences in humidity of the substrate to be printed. Therefore, printing systems may comprise pre-conditioning and post-conditioning mechanisms to condition the media before an image is transferred to the substrate or once it has been printed. In particular, it is herein disclosed a conditioning roller fora printing system comprising:
a roller body comprising an inner volume and an outer surface;
a conditioning media attached to the outer surface of the roller body;
a heating element; and
a fluid dispensing mechanism;
   wherein the heating element and the fluid dispensing mechanism are provided to act on the conditioning media from the inner volume of the roller body as to heat or wet the conditioning media.

In an example, the fluid dispensing mechanism comprises a fluid conductor, e.g., a hose or a tube, and a plurality of fluid passages from the inner surface of the roller body to the conditioning media. The plurality of passages may comprise a set of perforations on the roller body. Moreover, the plurality of passages may be to transfer fluid by capillarity from the inner volume of the roller body to the conditioning media.

As for the heating element, it may be a heating conduct associated to a fan to issue a hot air stream towards the inner volume of the roller body. In other examples, the heating element comprises a resistor, e.g., a tubular resistor.

In an example, the tubular resistor extends longitudinally spanning over a substantial distance along the roller body, e.g., 70% of the roller body or substantially the whole roller body.

In an example, the conditioning media comprises a foam and/or a fabric. The conditioning media is to act as an intermediate member between the fluid delivery mechanism or the heating mechanism and the substrate. The relevance of the conditioning media relies on its capacity to perform a more uniform transfer of heat/fluid towards the substrate.

Furthermore, it is described a printing system comprising a printing mechanism to apply a printing composition on a substrate and a conditioning roller associated to the printing mechanism, the conditioning roller comprising:
a roller body comprising an inner volume and an outer surface;
a conditioning media attached to the outer surface of the roller body;
a heating element and a fluid dispensing mechanism provided in the inner volume of the roller body;
   being the heating element to heat the substrate by the conditioning media and the fluid dispensing mechanism to moisture the substrate by the conditioning media.

In an example, the conditioning media is fluidly connected to the fluid dispensing mechanism by capillarity, i.e., the conditioning roller comprises capillary elements that provide a fluid communication between he fluid dispensing mechanism and the conditioning media.

In another example, the roller body comprises perforations as to allow heat to transfer from the heating element through the roller body the perforations defining a passage of heat from the conditioning roller towards the conditioning media.

Further, the heating element may comprise a tubular resistor spanning substantially the whole length of the roller body.

The printing system may also comprise a controller to select whether to activate the heating element or the fluid dispensing mechanism.

Also, a printing method is disclosed, the method comprising a pre-treatment stage and a printing stage being the pre-treatment stage prior to the printing stage and wherein the method is performed in a printer comprising:
a controller to receive instructions of a type of pretreatment to apply on a substrate being the type of pre-treatment one of drying the media or moisturizing the media;
a conditioning roller having an inner volume and an outer surface; and
a heating element and a fluid delivery mechanism provided in the inner volume;
   the controller being to activate the heating element upon receipt of an instruction to dry the media and to activate the fluid delivery mechanism upon receipt of an instruction to moisture the media.

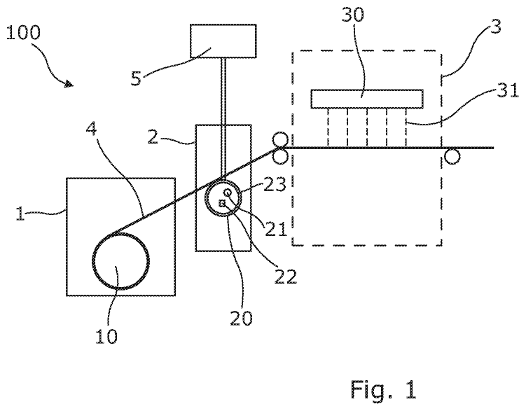

FIG. 1 illustrates an example of a printing system 100 that comprises a loading area 1, a conditioning area 2 and a print area 3 being the loading area 1 an area to wherein a substrate 4 is loaded, for example, in a roll format in a loading station such as a loading roller 10.

The conditioning area 2 is an area wherein the substrate 4 is conditioned as to achieve appropriate physical characteristics, the conditioning area 2 can be an area located upstream the printing area 3 and, in that case, the conditioning of the substrate 4 is performed to pre-treat the substrate to achieve appropriate conditions, e.g., moisture or temperature, before printing on such substrate. In a further example, the conditioning area 2 may be located downstream the printing area 3 as to perform a post-treatment on the substrate.

In an example, the conditioning area 2 comprises a conditioning roller 20 which is to act on the substrate 4 to modify a substrate parameter making it suitable to be used in a printing mechanism 30, in a post-processing mechanism, e.g., a drying or curing system or to be stored.

The conditioning roller 20 of FIG. 1 comprises roller body 24 that has an outer surface wherein a conditioning media 23 is attached and has an internal volume 200 wherein a heating element 21 and a fluid dispensing mechanism 22 are located.

Upon receipt of an instruction from a controller 5, the conditioning roller may activate, either the heating element 21 to heat the media and, therefore, dry it or the fluid dispensing mechanism 22 and, therefore, moisture the media by increasing its humidity. The controller 5 may send instructions to activate the heating element 21 or the fluid dispensing mechanism 22, e.g., in view of a signal obtained by a sensor, a pre-configured parameter or input by a user.

The conditioning media 23 may act as an intermediate element to transfer a fluid that is provided by the fluid dispensing mechanism towards the substrate 4. In particular, the conditioning media may receive conditioning fluid from the fluid delivery mechanism by capillarity. Also, the conditioning media 23 may receive heat from the heating element 21. In an example, the roller body 24 comprises a set of perforations that allow the passing of heat (e.g., heated air) from the heating element, through the body, towards the conditioning media, the conditioning media may then contact the substrate thereby transferring heat from the heating element 21 in a more uniform manner when compared to direct exposure to the heating element 21.

As for the printing area 3, it comprises a print mechanism 30 that is to deposit a print material 31 on the substrate 4 as to generate an image.

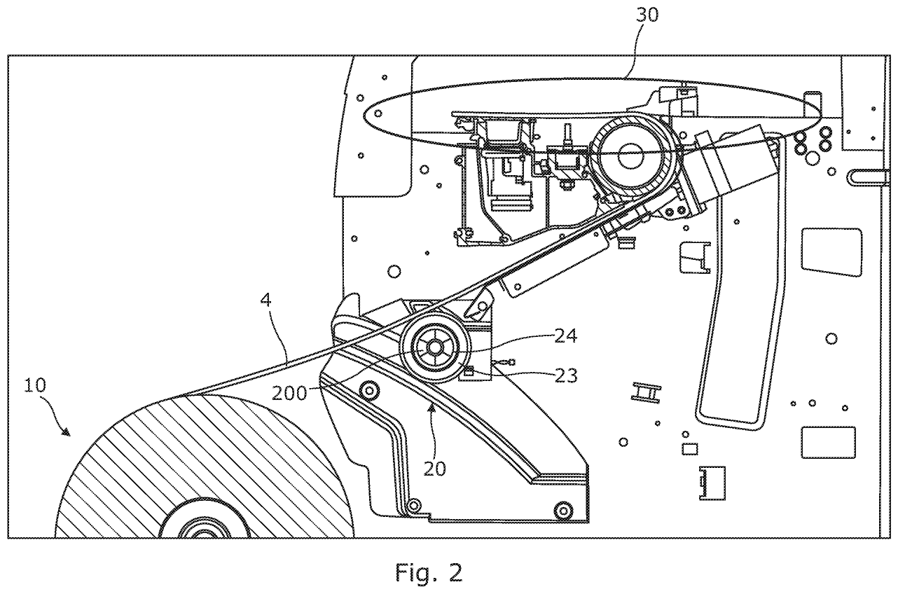

FIG. 2 is an example of printing system using inkjet technology. In the printing system of FIG. 2 the substrate 4 is loaded in a roll format and pre-treated by a conditioning roller 20 provided upstream the printing area 30.

As shown in cross-section of FIG. 2, the conditioning roller 20 has a roller body 24 that has an external surface wherein the conditioning material 23 is attached and an internal volume 200. The internal volume 200 is to accommodate the fluid delivery mechanism 22 and the heating element 21. In an example, the heating element 21 may be a flow of hot air that is provided through the volume and is transferred from an external element. Also, the fluid delivery mechanism 22 may comprise a fluid conductor or a plurality of fluid conductors that extend along the length of the conditioning roller 20 being such conductors provided with capillary elements to allow fluid to be transferred from the conductor to the conditioning media 23 or, in another example, a set of perforations on the conductor that allow the conditioning fluid to escape the conductor and flow towards the conditioning media 23.

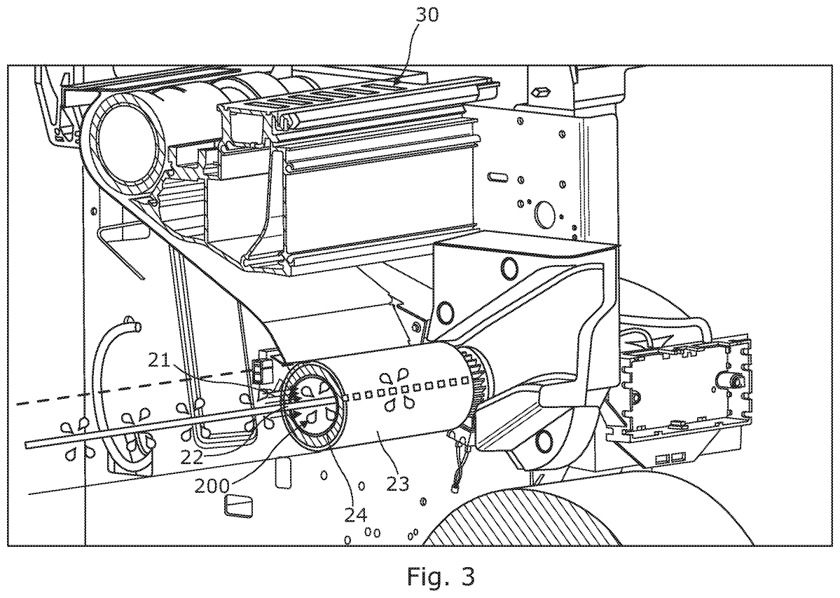

FIG. 3 shows a simplified example of a conditioning roller 20 installed on a printing system. In the example of FIG. 3, the conditioning roller is active as moisturizing roller, i.e., with the fluid delivery mechanism 22 activated. To activate the conditioning roller 20 as a moisturizing roller the controller is to issue a signal towards the conditioning roller 20 to activate the fluid delivery mechanism and deactivate the heating element.

In the example of FIG. 3 the fluid delivery mechanism comprises a conditioning fluid conductor 22 that is provided with holes or capillary elements to transfer conditioning fluid towards the conditioning media 23. Upon activation, a pump may be to impel conditioning fluid through the conductor 22 which, e.g., by capillary forces or by ejection through perforations is transferred to the conditioning media 23 which, in turn, is to contact the substrate (not shown) thereby wetting it and increasing its moisture.

In the example of FIG. 3, the heating element may be a flow of hot air 21 in the internal volume 200 of the conditioning roller 20, e.g., surrounding the conductor 22. Such air may be insufflated by a fan (not shown) that may be provided inside the internal volume or external to the conditioning roller 20.

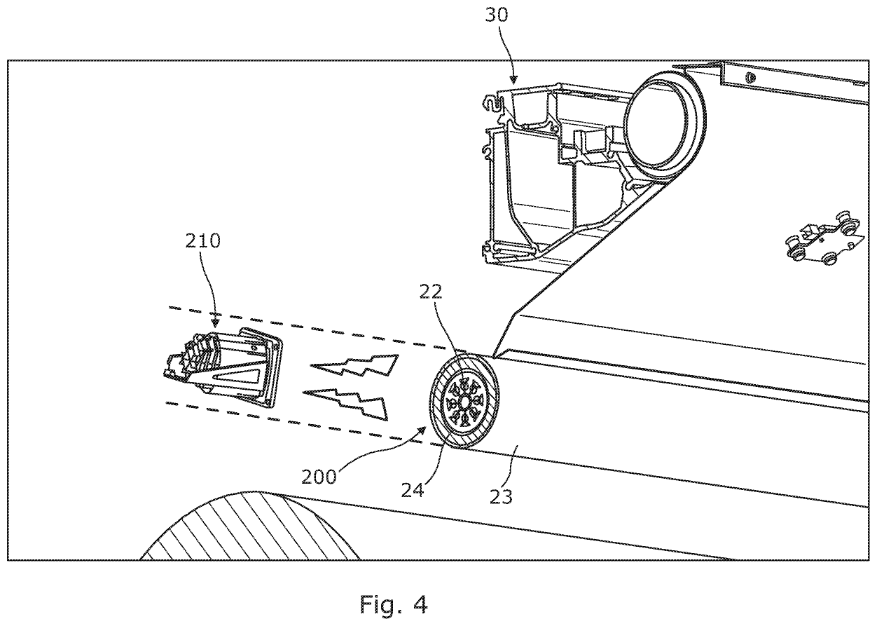

In a further example, as shown on FIG. 4, the conditioning 20 roller may act as a drying roller. In such a case, the conditioning roller 20 may act on to apply a heat on the substrate (not shown) using the conditioning media 23 as an intermediary element. To act as a drying roller, the controller 5 may issue a signal to activate the heating element. In the case of FIG. 4, the heating element may be air insufflated into the internal volume 200 by a fan 210 that may be provided outside the conditioning roller or as an element enclosed by the roller body 24.

Furthermore, the heating element may be a tubular resistance accommodated in the internal volume. In an example, the tubular resistance is provided in the internal volume and extends along the longitude of the roller spanning, at least, 70% of its longitude. In a further example, the tubular resistance spans at least 80% of the length of the conditioning roller 20, i.e., substantially the whole length of the conditioning roller 20.

The conditioning roller 20 of FIGS. 3 and 4 may, in an example, act exclusively either as a moisturizing roller or as a drying roller, i.e., if the fluid delivery mechanism is activated, the heat element may be inactivated and vice versa.

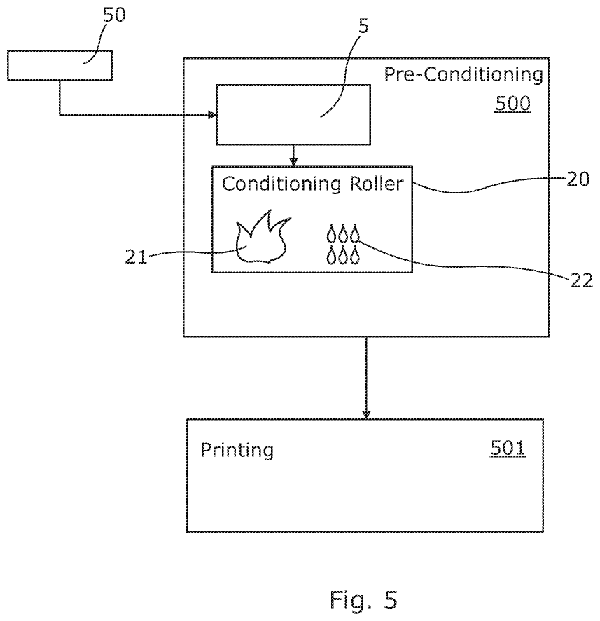

FIG. 5 shows an example of a printing method wherein a controller is to receive instructions 50 of the type of pre-conditioning to apply on a media. As explained above, these instructions may be pre-configured instructions, user input or inputs processed in view of readings from a sensor. Upon receipt of the instructions 50, the controller may decide the pre-conditioning 500 to apply.

The controller 5 may select what type of conditioning to apply on a substrate and instruct a conditioning roller 20 to activate the heating element 21 or activate the fluid delivery mechanism 22 depending on whether a drying instruction or a moistening instruction is received.

Once a pre-conditioning is performed, the method may comprise performing an image-forming or printing operation 501 on the substrate.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teachings. It is to be understood that any feature described in relation to any one example may be used alone, or in combination with other features described, and may also be used in combination with any features of any other of the examples, or any combination of any other of the examples. cm 1. A conditioning roller fora printing system comprising:
a roller body comprising an inner volume and an outer surface;
a conditioning media attached to the outer surface of the roller body;
a heating element; and
a fluid dispensing mechanism;
wherein the heating element and the fluid dispensing mechanism are provided to act on the conditioning media from the inner volume of the roller body as to heat or wet the conditioning media.

2. The conditioning roller of claim 1 wherein the fluid dispensing mechanism comprises a fluid conductor and a plurality of fluid passages from the inner surface of the roller body to the conditioning media

3. The conditioning roller of claim 2, wherein the plurality of passages comprises a set of perforations on the roller body.

4. The conditioning roller of claim 2, wherein the plurality of passages is to transfer fluid by capillarity from the inner volume of the roller body to the conditioning media.

5. The conditioning roller of claim 1 wherein the heating element comprises a fan to issue a hot air stream towards the inner volume of the roller body.

6. The conditioning roller of claim 1 wherein the heating element comprises a resistor.

7. The conditioning roller of claim 1 wherein the heating element comprises a tubular resistor.

8. The conditioning roller of claim 7, wherein the tubular resistor extends longitudinally spanning over 70% of the roller body.

9. The conditioning roller of claim 1 wherein the conditioning media comprises a foam and/or a fabric.

10. A printing system comprising a printing mechanism to apply a printing composition on a substrate and a conditioning roller associated to the printing mechanism, the conditioning roller comprising:
a roller body comprising an inner volume and an outer surface;
a conditioning media attached to the outer surface of the roller body;
a heating element and a fluid dispensing mechanism provided in the inner volume of the roller body;
being the heating element to heat the substrate by the conditioning media and the fluid dispensing mechanism to moisture the substrate by the conditioning media.

11. The printing system of claim 10, wherein the conditioning media is fluidly connected to the fluid dispensing mechanism by capillarity.

12. The printing system of claim 10, wherein the roller body comprises perforations as to allow heat to transfer from the heating element through the roller body.

13. The printing system of claim 10 wherein the heating element comprises a tubular resistor spanning substantially the whole length of the roller body.

14. The printing system of claim 10 further comprising a controller to select whether to activate the heating element or the fluid dispensing mechanism.

15. A printing method comprising a pre-treatment stage and a printing stage being the pre-treatment stage prior to the printing stage and wherein the method is performed in a printer comprising:
a controller to receive instructions of a type of pretreatment to apply on a substrate being the type of pre-treatment one of drying the media or moisturizing the media;
a conditioning roller having an inner volume and an outer surface; and
a heating element and a fluid delivery mechanism provided in the inner volume;
the controller being to activate the heating element upon receipt of an instruction to dry the media and to activate the fluid delivery mechanism upon receipt of an instruction to moisture the media.
